(19) United States
(12) Patent Application Publication
(10) Pub. No.: US 2025/0317352 A1
(43) Pub. Date: Oct. 9, 2025

(54) SYSTEMS AND DEVICES FOR NETWORK DATA COLLECTION, TRANSMISSION, AND PROCESSING

(71) Applicant: MELLANOX TECHNOLOGIES, LTD., Yokneam (IL)

(72) Inventors: Gal DALAL, Shimshit (IL); Benjamin FUHRER, Tel Aviv (IL); Chen TESSLER, Zichron Yaakov (IL); Yuval SHPIGELMAN, Netanya (IL); Gal YEFET, Haifa (IL); Doron HAIM, Herzliya (IL)

(73) Assignee: MELLANOX TECHNOLOGIES, LTD., Yokneam (IL)

(21) Appl. No.: 18/625,738

(22) Filed: Apr. 3, 2024

(51) Int. Cl. H04L 41/082

(52) U.S. Cl. CPC H04L 41/082

(57) ABSTRACT

Systems and devices for network data collection and processing are provided. An example system includes a first networked device and a centralized computing device communicably coupled with the at least one networked device. The first networked device operates to generate event-driven data entries associated with the first networked device and generate first data packets including the event-driven data entries and/or manipulated outputs generated based on manipulations to the event-driven data entries. The centralized computing device receives the first data packets from the first networked device and determines configuration updates based on the first data packets. The configuration updates are generated locally by the centralized computing device, and the centralized computing device transmits the one or more configuration updates to the first networked device.

### TECHNOLOGICAL FIELD

Embodiments of the present disclosure relate generally to networking and computing systems, and, more particularly, to network data collection, transmission, and processing in datacenter and other networking applications.

### BACKGROUND

Datacenters, high performance computing clusters, and/or the like are often implemented via distributed network components or devices (e.g., hosts, servers, racks, switches, nodes, etc.). For example, a datacenter or computing cluster may be formed of a plurality of networked devices that are communicably coupled with a centralized computing device and/or to one another. Each of these networked devices may generate data associated with the operations performed by the respective networked device. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure therefore provide for methods, systems, apparatuses, and computer program products for network data collection and processing. An example system for network data collection and processing may include a first networked device including at least a processor. The first networked device may be configured to generate one or more event-driven data entries associated with the first networked device and generate one or more first data packets including the one or more event-driven data entries and/or one or more manipulated outputs generated based on manipulations to the event-driven data entries. The system may further include a centralized computing device including at least a processor that is communicably coupled with the at least one networked device. The centralized computing device may be configured to receive the one or more first data packets from the first networked device and determined one or more configuration updates based at least in part on the one or more first data packets. The one or more configuration updates may be generated locally by the centralized computing device. The centralized computing device may subsequently transmit the one or more configuration updates to the first networked device.

In some embodiments, the first networked device may further include a first data buffer within which the first networked device aggregates event-driven data entries associated with the first networked device.

In some embodiments, the one or more first data packets may be transmitted by the first networked device to the centralized computing device via one or more Remote Direct Memory Access (RDMA) operations.

In some embodiments, the centralized computing device may further include a centralized data buffer within which the centralized computing device aggregates at least the one or more first data packets received from the first networked device.

In some embodiments, the first networked device may be further configured to receive the one or more configuration updates from the centralized computing device and modify one or more operations performed by the first networked device based on the one or more configuration updates.

In some embodiments, the first networked device may include a first data processing unit (DPU).

In some embodiments, the system may further include a second networked device including a processor and communicably coupled with the centralized computing device. In such an embodiment, the second networked device may be configured to generate one or more event-driven data entries associated with the second networked device and generate one or more second data packets including the one or more event-driven data entries of the second networked device.

In some further embodiments, the one or more event-driven data entries generated by the first networked device and the second networked device further include time data indicative of a time at which the respective event-driven data entries were generated.

In some further embodiments, the centralized computing device is further configured to perform one or more synchronization operations for the first networked device and the second networked device based on the time data of the event-driven data entries of the first networked device and the second networked device.

In some further embodiments, the centralized computing device may be further configured to receive the one or more second data packets from the second networked device and determine the one or more configuration updates based at least in part on the one or more first data packets and the one or more second data packets.

In some still further embodiments, the centralized computing device may be further configured to transmit the one or more configuration to the first networked device and the second networked device.

In some further embodiments, the second networked device may be further configured to receive the one or more configuration updates from the centralized computing device and modify one or more operations performed by the second networked device based on the one or more configuration updates.

In some further embodiments, the centralized computing device may further include a centralized data buffer within which the centralized computing device aggregates the one or more first data packets received from the first networked device and the one or more second data packets received from the second networked device.

In any embodiment, the first networked device, the second networked device, and the centralized computing device may be formed in a common datacenter cluster such that the first data packet generation by the first networked device, the second data packet generation by the second networked device, and the determination of the one or more configuration updates by the centralized computing device occur within the common datacenter cluster.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example datacenter cluster in accordance with an example embodiment of the present disclosure;

FIG. 2 illustrates a block diagram of example circuitry of an example networked device that may be specifically configured in accordance with an example embodiment of the present disclosure;

FIG. 3 illustrates an example data buffer within which an example networked device aggregates event-driven data entries in accordance with an example embodiment of the present disclosure;

FIG. 4 illustrates a block diagram of example circuitry of a centralized computing device that may be specifically configured in accordance with an example embodiment of the present disclosure;

FIG. 5 illustrates an example centralized data buffer within which an example centralized computing device aggregates data packets received from the networked device(s) in accordance with an example embodiment of the present disclosure;

FIG. 6 illustrates an example data processing unit (DPU) configuration that may operate as an example networked device and/or an example centralized computing device in accordance with one or more example embodiments of the present disclosure;

FIG. 7 illustrates a flowchart of an example method for generating event-driven data entries by a networked device in accordance with some embodiments of the present disclosure; and

FIG. 8 illustrates a flowchart of an example method for determining configuration updates by a centralized computing device in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or the like are often implemented via distributed network components or devices (e.g., hosts, servers, racks, switches, nodes, etc.). For example, a datacenter or computing cluster may be formed of a plurality of networked devices that are communicably coupled with a centralized computing device and/or to one another. In datacenters and other networking applications, low-level packet data is generated at a relatively high frequency and is associated with relatively low latency data streams. In conventional systems, however, event-driven data is either not collected or is collected in histograms with a low sampling rate resulting in sparse measurement data. This sparse measurement data is aggregated for examination offline by a user associated with the datacenter. As such, conventional systems fail to effectively provide an infrastructure that is adaptable to the dynamically changing conditions of datacenter environments that effectively captures low-level packet data at a sufficient frequency.

In order to address these problems and others, the embodiments of the present disclosure provide an infrastructure of devices for data collection, transmission, and processing that occurs within a datacenter cluster. For example, one or more networked devices (e.g., data transmitters/configuration receivers) generate data packets formed of event-driven data entries that are aggregated by the respective networked devices (e.g., in a buffer or otherwise). A centralized computing device (e.g., data receiver/configuration transmitter) receives these data packets and determines configuration updates for the networked devices based on these data packets. The configuration updates occur locally by the centralized computing device within a datacenter cluster so as to reduce or otherwise avoid any computational burden on other systems or components (e.g., at the host level or otherwise). The infrastructure of the present concept enables various lower level algorithms (e.g., congestion control, cluster wide zero thermal throttling (ZTT), node synchronization, etc.) that were previously unavailable at the datacenter cluster level.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Datacenter Cluster

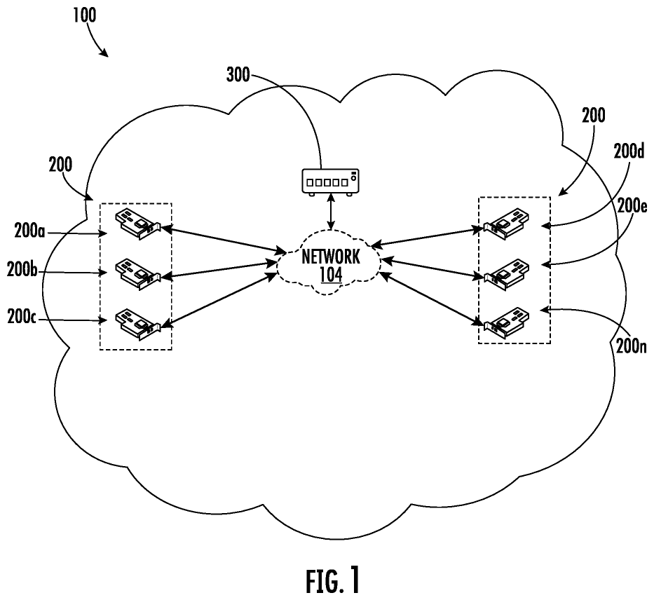

FIG. 1 illustrates an example datacenter cluster 100 with networked devices (e.g., a networked system, fabric, etc.). It will be appreciated that the system 100 is provided as an example of an embodiment(s) and should not be construed to narrow the scope or spirit of the disclosure. The depicted datacenter cluster 100 of FIG. 1 may include a centralized computing device 300 communicably coupled with one or more networked devices 200 (e.g., networked devices 200 a-n) via a network 104. The centralized computing device 300 may be configured to control or otherwise influence operations of the datacenter cluster 100 by, for example, generating configuration updates that at least partially impact the operations of the networked devices 200a-n forming the datacenter cluster 100. As described hereinafter, the centralized computing device 300 may operate as a data receiving device and configuration sending device in that the centralized computing device may receive data packets from respective networked devices 200a-n that include event-driven data (e.g., or modifications thereto), generate configuration updates based on the data packets, and distributed these configuration updates to the networked devices 200a-n. These operations, for example, may occur entirely within the datacenter cluster 100 or otherwise without the use of host-level computing resources (e.g., without burdening computing resources at different network levels, of different datacenter clusters, etc.).

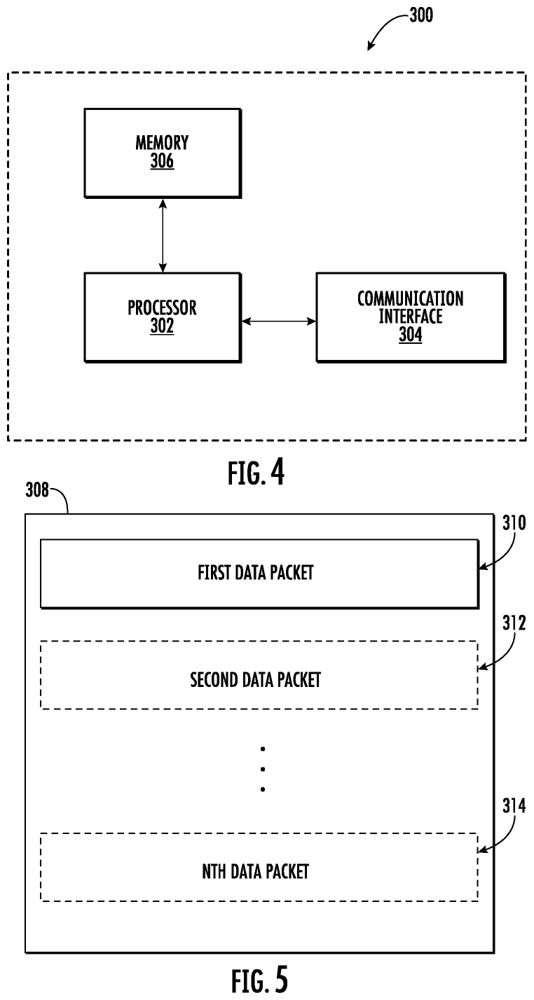

Although described hereinafter with reference to a centralized computing device 300, the present disclosure contemplates that the operations described hereafter with reference to the centralized computing device 300 (e.g., datacenter cluster level operations) may be performed by any computing device, system orchestrator, central processing unit (CPU), graphics processing unit (GPU), data processing unit (DPU) and/or the like. Furthermore, although illustrated as a single device (e.g., centralized computing device 300), the present disclosure contemplates that any number of distributed components may collectively be used to form the centralized computing device 300 and/or to perform the operations associated with the centralized computing device 300. As described above and hereinafter, the centralized computing device 300 may operate to manage the datacenter cluster 100. The centralized computing device 300 may take many forms or configurations but will include circuitry components configured to perform the operations described herein with reference to the centralized computing device 300, such as the example circuitry components illustrated in FIG. 4.

The datacenter cluster 100 may, as illustrated in FIG. 1, further include one or more networked devices 200a-n that are connected with the centralized computing device 300 via the network 104. As described herein, each of the networked device 200a-n may operate as a data generating device and a configuration receiving device in that the networked devices 200a-n may generate event-driven data entries that are associated with the respective networked device 200a-n, such as the associated with the operations of the respective networked device 200a-n. By way of a non-limiting example, the plurality of networked devices 200a-n may include a first networked device 200a that is configured to perform various operations. The first networked device 200a may be configured to generated event-drive data entries as described hereinafter that are associated with these operations performed by the first networked device 200a. Similarly, the plurality of networked devices 200a-n may include a second networked device 200b that is configured to perform various operations. The second networked device 200b may also be configured to generated event-drive data entries as described hereinafter that are associated with these operations performed by the second networked device 200b. Although described herein with reference to an example first and second networked devices 200a, 200b, the present disclosure contemplates that the datacenter cluster 100 may include any number of networked devices 200a-n in any configuration based on the intended application of the datacenter cluster 100.

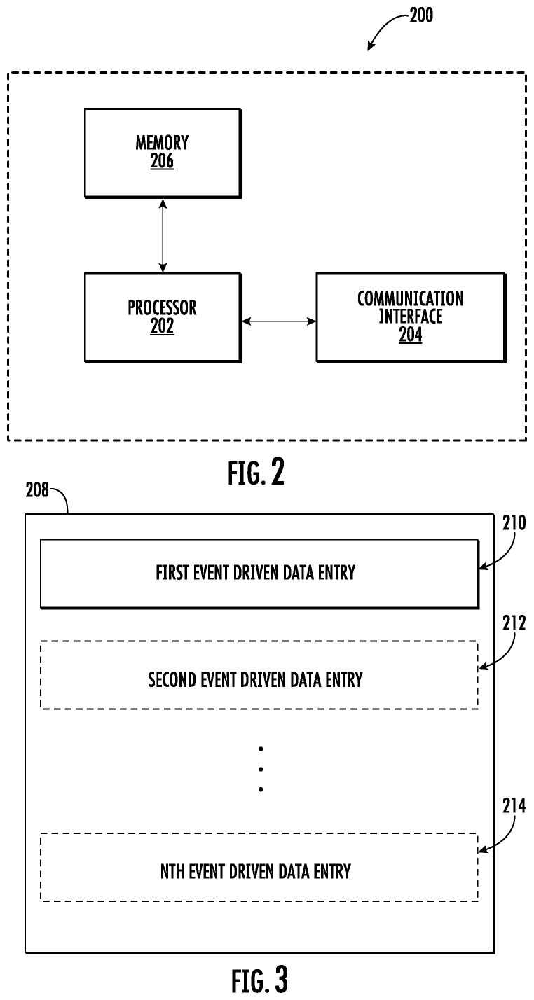

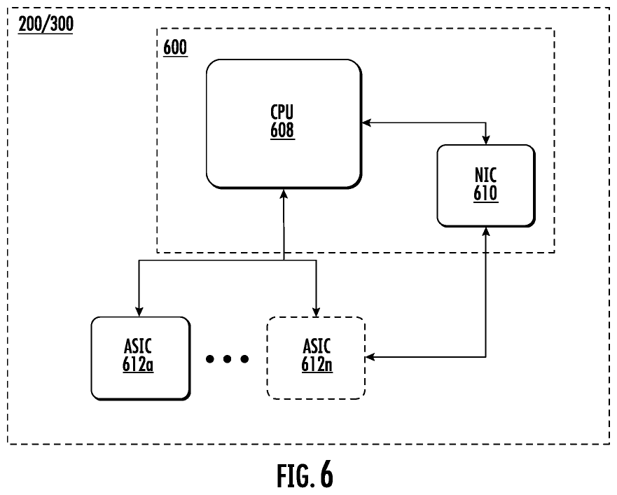

Although described hereinafter with reference to networked devices 200a-n, the present disclosure contemplates that the operations described hereafter with reference to various networked devices 200a-n (e.g., event-drive data generation and associated packet generation) may be performed by any computing device, system orchestrator, central processing unit (CPU), graphics processing unit (GPU), data processing unit (DPU) and/or the like. The networked devices 200a-n may take many forms or configurations but will include circuitry components configured to perform the operations described herein with reference to the networked devices 200a-n, such as the example circuitry components illustrated in FIG. 2. In some embodiments, each of the networked devices 200a-n may include the same or substantially the same circuitry components, such as in instances in which each of the networked devices 200a-n comprises a DPU (e.g., DPU 600 in FIG. 6). The present disclosure, however, contemplates that each of the networked devices 200a-n may include differing circuitry components, configurations, and/or the like based on the intended application of the respective networked device 200a-n. In some embodiments, each of the networked devices 200a-n may be configured to perform the same or substantially the same operations (e.g., in number, type, etc.). In other embodiments, one or more of the networked devices 200a-n may be configured to perform different operations (e.g., in number, type, etc.).

To facilitate or otherwise enable this connectivity in the datacenter cluster 100, the communication network 104 may be any means including hardware, software, devices, or circuitry that is configured to support the transmission of traffic (e.g., data, packets, signals, etc.) between the devices forming the datacenter cluster 100. For example, the communication network 104 may be formed of components supporting wired transmission protocols, such as, digital subscriber line (DSL), InfiniBand®, Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 104 may be comprised of any combination of the above mentioned protocols. In some embodiments, such as when networked devices 200a-n and the centralized computing device 300 are formed as part of the same physical device, the communication network 104 may include the on-board wiring providing the physical connection between the component devices. In some embodiments, the communication network 104 may enable remote direct memory access (RDMA) based communication. For example, the networked devices 200a-n may be configured to, in transmitting data packets, directly access the memory of the centralized computing device 300 without involving the operating system of the centralized computing device 300, and vice versa.

### Example Networked Device Circuitry

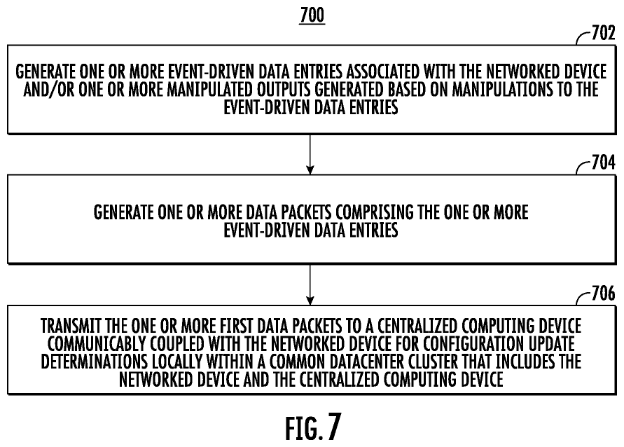

With reference to FIG. 2, example circuitry components of an example networked device 200 are illustrated that may, alone or in combination with any of the components described herein, be configured to perform the operations described herein with reference to FIG. 7. As shown, a networked device 200 may include, be associated with or be in communication with processor 202, a memory 206, and a communication interface 204. The processor 202 may be in communication with the memory 206 via a bus for passing information among components of the networked device 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202. As shown in FIG. 3, the memory 206 may be configured to at least partially store a data buffer 208 within which the networked device 200 aggregates event-driven data entries associated with the networked device 200.

The networked devices 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 204 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the networked device(s) 200 may provide or supplement the functionality of particular circuitry.

With reference to FIG. 3, an example first data buffer 208 within which an example the networked device 200 aggregates event-driven data entries associated with the networked device 200. As shown, the first data buffer 208 may be configured to store a first event driven data entry 210, a second event driven data entry 212, . . . , and Nth event driven data entry 214. As described hereinafter with reference to the operations of FIG. 7, an example first networked device 200a may be configured to generate event-driven data entries associated with operations of the first networked device 200a. Each of the event driven data entries 210, 212, 214 may include data indicative of any attribute, parameter, characteristic, etc. of the first networked device 200a as described herein. The present disclosure contemplates that the first data buffer 208 may include any number of event drive data entries 210, 212, 214 based on the operations of the first networked device 200a. Although described herein with reference to an example first data buffer 208 for the first networked device 200a, the present disclosure contemplates that each of the networked devices 200a-n may include a respective buffer within which the respective networked device 200a-n aggregates its respective event-drive data entries. The present disclosure further contemplates that the example data buffers (e.g., first data buffer 208) may be configured to store a one or more manipulated outputs generated based on manipulations to the event-driven data entries as described herein.

### Example Centralized Computing Device Circuitry

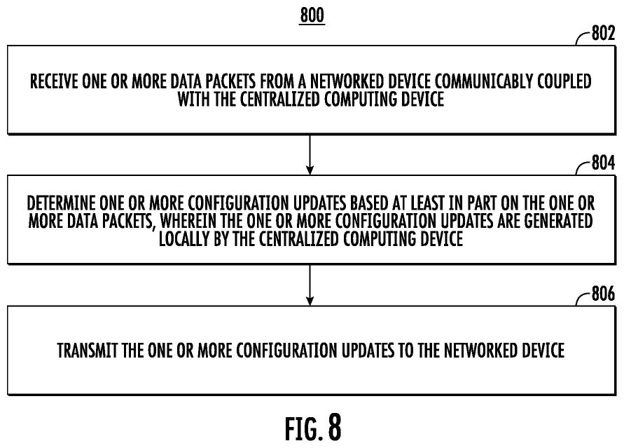

Similar to the networked devices 200, with reference to FIG. 4, example circuitry components of an example centralized computing device 300 are illustrated that may, alone or in combination with any of the components described herein, be configured to perform the operations described herein with reference to FIG. 8. As shown, the centralized computing device 300 may include, be associated with or be in communication with processor 302, a memory 306, and a communication interface 304. The processor 302 may be in communication with the memory 306 via a bus for passing information among components of the centralized computing device 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302. As shown in FIG. 5, the memory 306 may be configured to at least partially store a centralized data buffer 308 within which the centralized computing device 300 aggregates at least the one or more data packets received from the networked device(s) 200.

The centralized computing device 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 302 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 304 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the centralized computing device 300 may provide or supplement the functionality of particular circuitry.

With reference to FIG. 5, an example centralized data buffer 308 within which an example the centralized computing device 300 aggregates at least the one or more first data packets received from the networked device(s) 200 As shown, the centralized data buffer 308 may be configured to store a first data packet 310, a second data packet 312, . . . , and data packet 314. As described hereinafter with reference to the operations of FIG. 8, an example centralized computing device 300 may be configured to receive data packets from the networked device(s) 200 that includes event-driven data entries associated with operations of the networked device(s) 200. Each of the data packets 310, 312, 314 may include data indicative of any attribute, parameter, characteristic, etc. of the respective networked device 200 associated with the data packet. As such, in some embodiments, each of the data packets 310, 312, 314 may include one or more data entries identifying the networked device 200a-n associated with the data packet 310, 312, 314. The present disclosure contemplates that the centralized data buffer 308 may include any number of data packet 310, 312, 314 based on the operations of the centralized computing device 300 and/or the networked device(s) 200.

As described above and hereinafter, the networked device(s) 200 may be referred to as data transmitting devices and configuration receiving devices, and the centralized computing device 300 may be referred to as a data receiving device and a configuration transmitting device. Although described with reference to FIGS. 2 and 4 as potentially different device types (e.g., devices that may differ in circuitry components, hardware, and/or the like), the present disclosure contemplates that, in some embodiments, each of the devices 200, 300 forming the datacenter cluster 100 may be the same or substantially the same in hardware and/or operation, function, etc. By way of example, any of the devices 200, 300 forming the datacenter cluster 100 may operate as the centralized computing device 300 (e.g., any of the networked devices 200 may perform the operations described herein with reference to the centralized computing device 300). In such an embodiment, for example, a Message Passing Interface (MPI) communication protocol or other software abstraction may operate to automatically and autonomously select one of the networked devices 200 to operate as the centralized computing device 300. This categorization or designation of a networked device 200 as the centralized computing device 300 may occur without an explicit instruction by an entity associated with the datacenter cluster. Said differently, the present disclosure contemplates that any of the devices described herein may be configured to perform the operations associated with the centralized computing device 300 based on the intended application of the datacenter cluster 100.

### Example DPU Configuration

As described above, in some embodiments, one or more of the networked device(s) 200 and/or the centralized computing device 300 may include a DPU 600. With reference to FIG. 6, an example DPU 600 is illustrated that may, for example, operate, in whole or in part, as any of the networked devices 200 and/or the centralized computing device 300. Although described hereinafter with reference to an example DPU 600 performing at least a portion of the operations of FIGS. 7-8, the present disclosure contemplates that the operations described herein may be performed by any computing device (e.g., CPU, GPU, etc.) without limitation.

As shown in FIG. 6, the networked device(s) 200 and/or the centralized computing device 300 may include one or more application-specific integrated circuits (ASICs) 612a-n that are communicably coupled with a data processing unit (DPU) 600. The one or more ASICs 612a-n may be configured for performing one or more networking operations and may be specific to the particular functionality associated with the networked device(s) 200 and/or the centralized computing device 300. By way of non-limiting example, the one or more ASICs 612a-612n may be configured to operate as network ports in which traffic (e.g., data, signals, etc.) are directed to various components, devices, etc. communicably coupled with the ASICs 612a-n. The present disclosure contemplates that the networked device(s) 200 and/or the centralized computing device 300 may include any number of ASICs 612a-n (e.g., a plurality of ASICs 612a-n) based upon the intended application of the device(s) 200, 300. Additionally, the present disclosure contemplates that the operations performed by the one or more ASICs 612a-n may similarly vary based upon the intended application of the device(s) 200, 300. Still further, the present disclosure contemplates that the number, configuration, orientation, operations, etc. of the ASICs 612a-n may vary between device(s) 200, 300. As shown, the DPU 600 may include a high-performance, software-programmable CPU 608 that is communicably coupled with a network interface controller (NIC) 610.

### Example Methods for Event-Drive Data Generation

FIG. 7 illustrates a flowchart containing a series of operations for generating event-driven data entries by a networked device 200 (e.g., method 700). The operations illustrated in FIG. 7 may, for example, be performed by, with the assistance of, and/or under the control of an apparatus (e.g., networked device 200), as described above. In this regard, performance of the operations may invoke one or more of processor 202, memory 206, and/or communication interface 204.

As shown in operation 702, the apparatus (e.g., a first networked device 200a) includes means, such as processor 202, or the like, for generating one or more event-driven data entries associated with the first networked device 200a. As described above, first networked device 200a may operate as a data generating device and a configuration receiving device in that the first networked device 200a may generate event-driven data entries that are associated with the operations of the respective networked device 200a-n. As such, the event-driven data that is generated by the first networked device 200a may refer to any determinable, monitorable, or otherwise ascertainable parameters, characteristics, attributes, features, etc. associated with the first networked device 200a. By way of a non-limiting example, the event-driven data generated by the first networked device 200a may be associated with or indicative of the round trip time (RTT) for the first networked device 200a, the bandwidth utilization for the first networked device 200a (e.g., associated with statistics or other counters), telemetry data of any type or kind for the first networked device 200a, physical or environmental characteristics (e.g., temperature, pressure, etc.) for the first networked device 200a, and/or the like.

As would be evident to one of ordinary skill in the art in light of the present disclosure, the event-driven data generated by the first networked device 200a may refer to any data type that may be used in the lower level algorithms described herein. For example, the datacenter cluster 100 may include performance of congestion control algorithms, cluster wide zero thermal throttling (ZTT) algorithms, node synchronization algorithms, among others. As such, the event-driven data generated by the first networked device 200a may include data entries associated with the performance of at least these algorithms. By way of a non-limiting example, the devices 200, 300 of the datacenter cluster 100 may be configured to perform congestion control related algorithms locally at the datacenter cluster level. As such, the event-driven data generated by the first networked device 200a may, for example, be associated with the bandwidth utilization for the first networked device 200a. By way of an additional, non-limiting example, the devices 200, 300 of the datacenter cluster 100 may be configured to perform synchronization related algorithms locally at the datacenter cluster level. As such, the event-driven data generated by the first networked device 200a may, for example, be associated time data indicative of a time at which the respective event-driven data entries were generated by the first networked device 200a. Although described herein with reference to an example congestion control algorithm or synchronization algorithm, the present disclosure contemplates that the event-driven data may be associated with any algorithm based on the intended application of the datacenter cluster 100. The present disclosure contemplates that the operations regarding the first networked device 200a may be applicable to any of the networked devices 200a-n. By way of example, a second networked device 200b may be configured to generate one or more event-driven data entries associated with the second networked device 200b, such as time data indicative of a time at which the respective event-driven data entries were generated by the second networked device 200b.

Thereafter, as shown in operation 704, the apparatus (e.g., first networked device 200a) includes means, such as processor 202, or the like, for generating one or more first data packets comprising the one or more event-driven data entries. The first data packets described herein may refer to the data structure by which the event-driven data generated by the first networked device 200a is provided to the centralized computing device 300 as described herein. As such, the first data packets may include any structure, configuration, etc. required by the datacenter cluster 100 in order for these event-driven data to be provided to the centralized computing device 300. The first networked device 200a may, in some instances, manipulate the generated event-driven data at the first networked device 200a such that the first data packets also include or one or more manipulated outputs generated based on manipulations to the event-driven data entries. As described above with reference to FIG. 3, the first networked device 200 a may further include a first data buffer 208 within which the first networked device 200a aggregates event-driven data entries associated with the first networked device 200a. The present disclosure again contemplates that the operations regarding the first networked device 200a may be applicable to any of the networked devices 200a-n. By way of example, a second networked device 200b may be configured to generate one or more second data packets comprising the one or more event-driven data entries and/or one or more manipulated outputs generated based on manipulations to the event-driven data entries for the second networked device 200b.

Thereafter, as shown in operation 706, the apparatus (e.g., first networked device 200a) includes means, such as processor 202, or the like, for transmitting the one or more first data packets to the centralized computing device 300 communicably coupled with the first networked device 200a for configuration updates determinations locally within a common datacenter cluster 100 that includes the first networked device 200a and the centralized computing device 300. As described hereinafter with reference to FIG. 8, the centralized computing device 300 may be configured to receive a plurality of data packets from a plurality of the networked device 200a-n forming the datacenter cluster 100 so as to generate configuration updates that modify the operations performed by the networked devices 200a-n. By leveraging the infrastructure described herein, the embodiments of the present disclosure may accomplish this configuration update at the datacenter cluster 100 level (e.g., without offline user input, without impacting other network devices or levels, etc.). As described above, in some embodiments, the one or more data packets may be transmitted by the networked device(s) 200a-n to the centralized computing device 300 via one or more RDMA operations.

### Example Methods for Event-Drive Data Generation

FIG. 8 illustrates a flowchart containing a series of operations for determining configuration updates by a centralized computing device 300 (e.g., method 800). The operations illustrated in FIG. 8 may, for example, be performed by, with the assistance of, and/or under the control of an apparatus (e.g., centralized computing device 300), as described above. In this regard, performance of the operations may invoke one or more of processor 302, memory 306, and/or communication interface 304.

As shown in operation 802, the apparatus (e.g., centralized computing device 300) includes means, such as processor 302, or the like, for receiving the one or more first data packets from the first networked device coupled with the centralized computing device 300. As described above with reference to FIG. 7, the networked devices 200a-n of the datacenter cluster 100 may generated event-driven data associated with the operation of the respective networked device 200a-n and transmit this data to the centralized computing device 300 via respective data packets. As described above with reference to FIG. 5, in some embodiments, the centralized computing device 300 further comprises a centralized data buffer 308 within which the centralized computing device 300 aggregates the data packets received from the networked devices 200a-n.

As shown in operation 804, the apparatus (e.g., centralized computing device 300) includes means, such as processor 302, or the like, for determine one or more configuration updates based at least in part on the one or more data packets where the one or configuration updates are generated locally by the centralized computing device 300. As described above, the event-driven data generated by the networked devices 200a-n may refer to any data type that may be used in the lower level algorithms described herein. By way of continued example, the datacenter cluster 100 may include performance of congestion control algorithms, cluster wide zero thermal throttling (ZTT) algorithms, node synchronization algorithms, among others. As such, the configuration updates described herein may refer to instructions for modifying the operations of the respective networked devices 200a-n as related to performance of these algorithms.

By way of continued example, the devices 200, 300 of the datacenter cluster 100 may be configured to perform congestion control related algorithms locally at the datacenter cluster level. As such, the event-driven data generated by the networked devices 200 (e.g., the first networked device 200a, the second networked device 200b, etc.) may, for example, be associated with the bandwidth utilization for the networked devices 200. In such an embodiment, the centralized computing device 300 may operate to determine configuration updates that modify the operations of the networked devices 200 based on this bandwidth utilization. Such a configuration update may, for example, refer to a change in processor utilization, assigned operations/jobs, etc. for the networked devices 200 in order to improve the operation of the datacenter cluster 100 (e.g., a congestion control algorithm implementation).

By way of an additional, non-limiting example, the devices 200, 300 of the datacenter cluster 100 may be configured to perform synchronization related algorithms locally at the datacenter cluster level. As such, the event-driven data generated by the networked devices 200a-n may, for example, be associated time data indicative of a time at which the respective event-driven data entries were generated by the respective networked device 200a-n. In such an embodiment, the centralized computing device 300 may operate to determine configuration updates that synchronize operations for the example first networked device 200a and the second networked device 200b based on the time data of the event-driven data entries of the first networked device 200a and the second networked device 200b. Such a synchronization operation may be implemented for any of the network devices 200 and effectuated via the configuration updates described herein. Although described herein with reference to an example congestion control algorithm or synchronization algorithm, the present disclosure contemplates that the configuration updates may be associated with any algorithm based on the intended application of the datacenter cluster 100.

Thereafter, as shown in operation 806, the apparatus (e.g., centralized computing device 300) includes means, such as processor 302, or the like, for transmitting the one or more configuration updates to the networked devices 200. By way of continued example, the networked devices 200 may be configured to perform various operations and the way in which these networked device 200 are configured may vary based on the attributes, characteristics, parameters, etc. associated with each respective networked device 200. The centralized computing device 300 may transmit the determined configuration updates to the networked devices 200, and each of the networked devices 200 (e.g., first networked device 200a, the second networked device 200b, etc.) may receive these configuration updates. In response, each of the networked devices 200 may modify one or more operations performed by the respective networked device 200 based on the one or more configuration updates. By way of continued example, the configuration updates for the first networked device 200a and/or the second networked device may modify processor utilization (e.g., in an example congestion control implementation), set clock signals (e.g., in a synchronization situation), and/or the like. The present disclosure contemplates that the configuration updates may modify any condition, parameter, attribute, characteristic of the networked devices 200 without limitation based on the application of the datacenter cluster 100.

In some embodiments, the networked device(s) 200 and the centralized computing device 300 may leverage various Application Programming Interfaces (APIs) in order to perform the operations of the networked device(s) 200 (e.g., data transmitting and configuration receiving) and/or of the centralized computing device 300 (e.g., data receiving and configuration transmitting). By way of a non-limiting example, the networked device(s) 200 (e.g., or any data transmitting device) may operate to perform a “collect_into_buffer( ) #” operation in which a data trace of fixed length is generated (e.g., first data packets of event-driven data). The networked device may subsequently perform a “send_buffer(destination_list) #” operation in which the data in the data buffer 208 is provided to a list of destination devices (e.g., at least the centralized computing device 300). The networked device(s) (e.g., or any configuration receiving device) may operate to perform a “receive_configuration(source_list) #” operation in which the networked device 200 awaits incoming configuration from a configuration publisher (e.g., the centralized computing device 300). Thereafter, the networked device 200 may perform a “load_configuration(configuration) #” operation locally in order to load new configuration updates as described herein.

By way of continued example, the centralized computing device 300 (e.g., or any data receiving device) may operate to perform a “receive_incoming_data(sender_list, buffer) #” operation in which the centralized computing device 300 awaits incoming data traces listed on the sender_list on the same datacenter cluster 100 and stores these data traces in the centralized data buffer 308. The centralized computing device 300 (e.g., or any configuration transmitting device) may operate to perform a “publish_configuration(destination_list) #” operation in which configuration updates are provided to each of the networked device(s) 200 in the destination list. Thereafter, the centralized computing device 300 may perform a “request_data(destination_list) #” operation to request data transmitting devices to provide data traces as described above. As would be evident to one of ordinary skill in the art in light of the present disclosure, the above API is only one such example API and may vary based on the intended application of the datacenter cluster 100.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A system for network data collection and processing, the system comprising:
a first networked device comprising at least a processor, wherein the first networked device is configured to generate one or more first data packets comprising one or more event-driven data entries associated with the first networked device and/or one or more manipulated outputs generated based on manipulations to the event-driven data entries;
a centralized computing device comprising at least a processor, wherein the centralized computing device is communicably coupled with the at least one networked device and configured to:
receive the one or more first data packets from the first networked device;
determined one or more configuration updates based at least in part on the one or more first data packets, wherein the one or more configuration updates are generated locally by the centralized computing device; and
transmit the one or more configuration updates to the first networked device.

2. The system according to claim 1, wherein the first networked device further comprises a first data buffer within which the first networked device aggregates event-driven data entries associated with the first networked device.

3. The system according to claim 1, wherein the one or more first data packets are transmitted by the first networked device to the centralized computing device via one or more Remote Direct Memory Access (RDMA) operations.

4. The system according to claim 1, wherein the centralized computing device further comprises a centralized data buffer within which the centralized computing device aggregates at least the one or more first data packets received from the first networked device.

5. The system according to claim 1, wherein the first networked device is further configured to:
receive the one or more configuration updates from the centralized computing device; and
modify one or more operations performed by the first networked device based on the one or more configuration updates.

6. The system according to claim 1, wherein the first networked device comprises a first data processing unit (DPU).

7. The system according to claim 1, further comprising a second networked device comprising a processor and communicably coupled with the centralized computing device, wherein the second networked device is configured to:
generate one or more event-driven data entries associated with the second networked device; and
generate one or more second data packets comprising the one or more event-driven data entries of the second networked device.

8. The system according to claim 7, wherein the one or more event-driven data entries generated by the first networked device and the second networked device further comprise time data indicative of a time at which the respective event-driven data entries were generated.

9. The system according to claim 8, wherein the centralized computing device is further configured to perform one or more synchronization operations for the first networked device and the second networked device based on the time data of the event-driven data entries of the first networked device and the second networked device.

10. The system according to claim 7, wherein the centralized computing device is further configured to:
receive the one or more second data packets from the second networked device; and
determine the one or more configuration updates based at least in part on the one or more first data packets and the one or more second data packets.

11. The system according to claim 10, wherein the centralized computing device is further configured to transmit the one or more configuration to the first networked device and the second networked device.

12. The system according to claim 10, wherein the second networked device is further configured to:
receive the one or more configuration updates from the centralized computing device; and
modify one or more operations performed by the second networked device based on the one or more configuration updates.

13. The system according to claim 7, wherein the centralized computing device further comprises a centralized data buffer within which the centralized computing device aggregates:
the one or more first data packets received from the first networked device; and
the one or more second data packets received from the second networked device.

14. The system according to claim 7, wherein the first networked device, the second networked device, and the centralized computing device are formed in a common datacenter cluster such that the first data packet generation by the first networked device, the second data packet generation by the second networked device, and the determination of the one or more configuration updates by the centralized computing device occur within the common datacenter cluster.

15. A networked device comprising:
a non-transitory storage device; and
a processor coupled to the non-transitory storage device, wherein the processor is configured to:
generate one or more event-driven data entries associated with the networked device and/or one or more manipulated outputs generated based on manipulations to the event-driven data entries;
generate one or more data packets comprising the one or more event-driven data entries; and
transmit the one or more first data packets to a centralized computing device communicably coupled with the networked device for configuration updates determinations locally within a common datacenter cluster that includes the networked device and the centralized computing device.

16. The networked device according to claim 15, wherein the networked device further comprises a data buffer within which the networked device aggregates event-driven data entries associated with the networked device.

17. The networked device according to claim 15, wherein the processor is further configured to:
receive one or more configuration updates from the centralized computing device generated based at least in part on the one or more data packets transmitted by the networked device; and
modify one or more operations performed by the networked device based on the one or more configuration updates.

18. A centralized computing device comprising:
a non-transitory storage device; and
a processor coupled to the non-transitory storage device, wherein the processor is configured to:
receive one or more data packets from a networked device communicably coupled with the centralized computing device, wherein the one or more data packets comprise one or more event-driven data entries associated with the networked device and/or one or more manipulated outputs generated based on manipulations to the event-driven data entries;
determine one or more configuration updates based at least in part on the one or more data packets, wherein the one or more configuration updates are generated locally by the centralized computing device; and
transmit the one or more configuration updates to the networked device.

19. The centralized computing device according to claim 18, further comprising a centralized data buffer within which the centralized computing device aggregates at least the one or more data packets received from the networked device.

20. The centralized computing device according to claim 18, wherein the one or more configuration updates are configured to modify one or more operations performed by the networked device.
